(19) United States
(12) Patent Application Publication
(10) Pub. No.: US 2022/0329841 A1
(43) Pub. Date: Oct. 13, 2022

(54) METHOD FOR ENCODING AUDIO AND VIDEO DATA, AND ELECTRONIC DEVICE

(71) Applicant: BEIJING DAJIA INTERNENT INFORMATION TECHNOLOGY CO, LTD, Beijing (CN)

(72) Inventor: Jianfeng ZHENG, Beijing (CN)

(21) Appl. No.: 17/843,861

(22) Filed: Jun. 17, 2022

Related U.S. Application Data
(63) Continuation of application No. PCT/CN2021/072152, filed on Jan. 15, 2021.

(30) Foreign Application Priority Data
Jan. 17, 2020 (CN) 202010054626.6

(51) Int. Cl. H04N 19/46; G10L 19/16

(52) U.S. Cl. CPC H04N 19/46; G10L 19/167

(57) ABSTRACT

Provided is a method for encoding audio and video data. The method includes: encapsulating cached elementary stream (ES) data of audio frames into an audio packetized elementary stream (PES) packet, and then splitting the audio PES packet into consecutive audio transport stream (TS) packets; and outputting one or more audio TS packet groups based on an order of the audio frames, and outputting one or more video TS packet groups based on an order of the video frames; wherein the one or more video TS packet group is present between the audio TS packet groups belonging to a same audio PES packet, and the one or more audio TS packet group is present between the video TS packet groups belonging to different video PES packets.

### CROSS-REFERENCE TO RELATED APPLICATION

The present disclosure is a continuation application of International Application No. PCT/CN2021/072152, filed on Jan. 15, 2021, which claims priority to the Chinese Application No. 202010054626.6, filed on Jan. 17, 2020, the contents of which are incorporated herein by reference in their entireties.

### TECHNICAL FIELD

The present disclosure relates to the field of data processing technologies, and particularly, relates to a method for encoding audio and video data, and an electronic device.

### BACKGROUND

In the current MPEG-transport Stream (MPEG-TS MPEG) encapsulating process, audio frames are cached during encoding, the cached audio frames are encapsulated into an audio packetized elementary stream (PES) packet in the case that cached audio data reaches a cache size, and the PES packet is split into an audio transport stream (TS) packet to output; video frames are cached during encoding, the video frames are encapsulated into a video PES packet in a single frame unit, and the video PES packet is split into a video TS packet to output.

### SUMMARY

Embodiments of the present disclosure provide a method for encoding audio and video data, and an electronic device. The technical solutions of the present disclosure are as follows.

According to some embodiments of the present disclosure, a method for encoding audio the video data is provided. The method, applicable to an audio and video encoder, includes:

encapsulating cached elementary stream (ES) data of audio frames into at least one audio packetized elementary stream (PES) packet, and encapsulating cached ES data of video frames into at least one video PES packet, wherein the audio frames and the video frames belong to a same video file;

splitting the audio PES packet into at least two consecutive audio transport stream (TS) packets, and splitting the video PES packet into at least two consecutive video TS packets; and

outputting one or more audio TS packet groups based on an order of the audio frames, and outputting one or more video TS packet groups based on an order of the video frames, wherein the audio TS packet group includes at least one audio TS packet, and the video TS packet group includes at least one video TS packet;

wherein in an output order of the one or more audio TS packet groups and the one or more video TS packet groups, at least one of the one or more video TS packet groups is present between the audio TS packet groups belonging to a same audio PES packet, and at least one of the one or more audio TS packet groups is present between the video TS packet groups belonging to different video PES packets.

According to some embodiments of the present disclosure, an electronic device is provided.

The electronic device includes:

a processor; and

a memory configured to store one or more instructions executable by the processor:

wherein the processor, when loading and executing the one or more instructions, is caused to perform:

encapsulating cached elementary stream (ES) data of audio frames into at least one audio packetized elementary stream (PES) packet, and encapsulating cached ES data of video frames into at least one video PES packet, wherein the audio frames and the video frames belong to the same video file;

splitting the audio PES packet into at least two consecutive audio transport stream (TS) packets, and splitting the video PES packet into at least two consecutive video TS packets; and

outputting one or more audio TS packet groups based on an order of the audio frames, and outputting one or more video TS packet groups based on an order of the video frames, wherein the audio TS packet group includes at least one audio TS packet, and the video TS packet group includes at least one video TS packet;

wherein in an output order of the one or more audio TS packet groups and the one or more video TS packet groups, at least one of the one or more video TS packet group is present between the audio TS packet groups belonging to a same audio PES packet, and at least one of the one or more audio TS packet groups is present between the video TS packet groups belonging to different video PES packets.

According to some embodiments of the present disclosure, a non-transitory computer readable storage medium storing one or more instructions therein is provided. The one or more instructions, when loaded and executed by a processor of an electronic device, cause the electronic device to perform:

encapsulating cached elementary stream (ES) data of audio frames into at least one audio packetized elementary stream (PES) packet, and encapsulating cached ES data of video frames into at least one video PES packet, wherein the audio frames and the video frames belong to a same video file;

splitting the audio PES packet into at least two consecutive audio transport stream (TS) packets, and splitting the video PES packet into at least two consecutive video TS packets; and

outputting one or more audio TS packet groups based on an order of the audio frames, and outputting one or more video TS packet groups based on an order of the video frames, wherein the audio TS packet group includes at least one audio TS packet, and the video TS packet group includes at least one video TS packet;

wherein in an output order of the one or more audio TS packet groups and the one or more video TS packet groups, at least one of the one or more video TS packet groups is present between the audio TS packet groups belonging to a same audio PES packet, and at least one of the one or more audio TS packet groups is present between the video TS packet groups belonging to different video PES packets.

### BRIEF DESCRIPTION OF THE DRAWINGS

FIG. 1 is a schematic diagram of interleaving and encoding audio and video data according to an embodiment;

FIG. 2 is a schematic diagram of encapsulating and splitting audio and video data according to an embodiment;

FIG. 3 is a schematic diagram of alternately encoding audio and video data according to an embodiment;

FIG. 4 is a schematic diagram of a time division multiplexing according to an embodiment;

FIG. 5 is a flowchart of a method for encoding audio and video data according to an embodiment;

FIG. 6A is a schematic diagram of splitting an audio and video PES packet according to an embodiment;

FIG. 6B is a schematic diagram of alternately encoding audio and video data frame by frame according to an embodiment;

FIG. 6C is a schematic diagram of alternately encoding audio and video data frame by frame according to an embodiment;

FIG. 7 is a schematic diagram of alternately outputting an audio TS packet group and a video TS packet group according to an embodiment;

FIG. 8 is a flowchart of alternately encoding audio and video data frame by frame according to an embodiment;

FIG. 9 is a flowchart of a method for encoding audio and video data in a fashion of grouping and outputting simultaneous according to an embodiment;

FIG. 10 is a block diagram of an apparatus for encoding audio and video data according to an embodiment;

FIG. 11 is a block diagram of an electronic device according to an embodiment;

FIG. 12 is a block diagram of a process device according to an embodiment.

### DETAILED DESCRIPTION

For the terms “at least one.” “a plurality of,” and “each,” in the present disclosure, the term “at least one” includes one, two, or more, the term “a plurality of” includes two or more, and the term “each” means every of corresponding “the plurality of.” For example, a plurality of audio TS packets include three audio TS packets, each of the plurality of audio TS packets means every audio TS packet of the three audio TS packets, and at least one of the plurality of audio TS packets means one, two, or three of the three audio TS packets.

It is to be noted that the user data (including, but not limited to, user device data, user personal data, and the like) in the present disclosure is data that is authorized by the user or sufficiently authorized by the parties.

Some terms in the present disclosure are explained hereinafter:

1. The term “and/or” describes an associated relationship of associated objects, and means three relationships. For example, A and/or B means that A exists alone, A and B exist simultaneously. B exists alone. The symbol “/” indicates that the associated objects are in an “or” relationship.

2. An electronic device is a mobile phone, a computer, a digital broadcast terminal, a messaging device, a gaming console, a tablet device, a medical device, an exercise device, a personal digital assistant, or the like.

3. A Moving Picture Experts Group (MPEG) is an organization of the International Organization for Standardization/International Electrotechnical Commission (ISO/IEC) to specifically formulate international standards for motion images and speech compression.

MPEG2, i.e., ISO/IEC13818, is a second generation audio and video lossy compression standard formulated by the MPEG organization, the formal name of which is the compression standard of motion image and audio based on the digital storage media.

MPEG2-TS is an MPEG transport stream. The MPEG2 standard includes a plurality of portions, the transport stream (TS) standard associated with the embodiments of the present disclosure is the first part of the MPEG2 standard ISO/IEC 13818-1 or the audio and video transport stream standard defined by the International Telecommunication Union Telecommunication Standardization Sector (ITU-T) Rec. H.222.0.

4. An elementary stream (ES) refers to a video compression stream or audio stream that is not encapsulated by an MPEG2-TS, such as a video compression stream defined by a second part of the MPEG2 standard (ISO/IEC 13818-2 or ITU-T Rec. H.262), or an H.264 video compression stream defined by ITU-T Rec. H.264 standard. PES refers to a encapsulating configuration of data defined by MPEG2-TS.

5. FFmpeg is an open source computer program configured to record digital audio and video, and convert the digital audio and video into a stream, which provides a complete solution of recording, converting, and streaming audio and video.

6. A video encoding fashion refers to a fashion of converting a file from one video form to another video form by a specific compression technology. The codec standard in the process of transporting video stream in the present disclosure is H.264 or other, wherein H.264 refers to a video compression method or a video compression stream defined in the ISO/IEC 14496-10 or ITU-T Rec. H.264 standard. Optionally, the codec standard in the process of transporting audio stream in the present disclosure is advanced audio coding (AAC) or other, wherein AAC refers to an audio compression method or an audio compression data stream defined in the ISO/IEC 13818-7 standard.

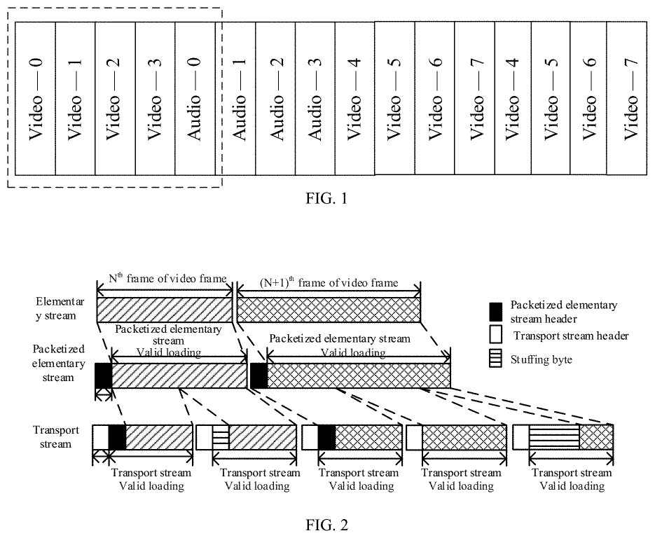

As shown in FIG. 1, as a video screen and an audio should be played simultaneously when playing the video, the code stream obtained in the encoding fashion in the related art may cause block piled-up audio and video ES data. Because of the block build-up audio data, the audio data is transmitted in response to transmitting the video data block. That is, upon acquiring Video-0 to Video-3 and Audio-0 within the dotted line, the video screen and the audio start to play. The audio and video ES data includes ES data of audio frames and ES data of video frames.

The encoding process in the related art is shown in FIG. 2. ES data of the audio and video is encapsulated into a PES packet by MPEG2-TS. The PES packet includes the ES data of the N^{th} frame of video frame (or ES data of audio frames) and the ES data of the (N+1)^{th} frame video frame, and a PES H represents a PES header. Then, the PES packet is split into the TS packet of fixed 188 bytes. The term “splitting” refers to dividing and encapsulating. That is, the PES packet is split into a plurality of packets, the packets are encapsulated into a TS packet, and a TS H represents a TS packet header. The TS packet is the minimum transmission unit specified by the MPEG2-TS transport stream. The first 4 bytes of each TS packet are header data describing data associated with the TS packet; the remaining 184 bytes carry data blocks of the PES.

However, the MPEG-TS data encapsulating structure is confronted with a problem that the last TS packet corresponding to the PES packet needs to be inserted with some stuffing bytes in the case that the PES packet size is not an integer multiple of 184 bytes, as shown in the gray portion shown in FIG. 2. As one PES packet can be encapsulated with one or more frames of audio frames, a plurality of frames of audio frames are combined into one PES packet during encoding in the related art.

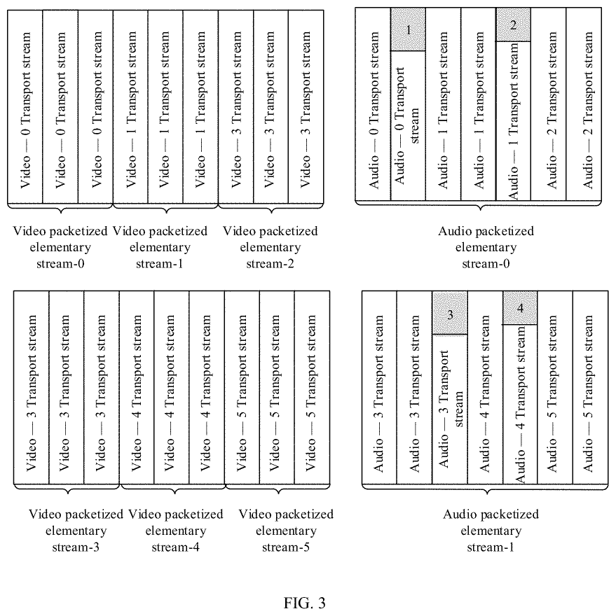

As shown in FIG. 3, a schematic diagram of alternately encoding audio and video data is shown according to the related art. Video i TS represents the TS packet belonging to i^{th} frame video frame (i=0, 1, 2, 3, 4, 5), for example, Video-0 TS represents the TS packet belonging to the 0^{th} frame video frame. Audio-j TS represents the TS packet belonging to the j^{th} frame audio frame (j=0, 1, 2, 3, 4, 5), for example. Audio-0 TS represents the TS packet belonging to the 0^{th} frame audio frame; Video-PES-0 to Video-PES-5 represents the first to sixth video PES packets; Audio-PES-0 represents the first audio PES packet, and Audio-PES-1 represents the second audio PES packet. The same video PES packet includes the ES data of one frame of video frame, the same audio PES packet includes the ES data of a plurality of frames of audio frame. For example, Video-PES-0 merely includes the ES data of 0^{th} frame video frame, which includes 3 video TS packets; and Audio-PES-0 includes three frames of audio frames of ES data of 0^{th} to second frames, which includes seven audio TS packets. The gray portions 1 to 4 in the FIG. 3 refer to the headers of Audio-1 to Audio-4. The audio frames are not aligned according to the TS packets, the header of Audio-1 and the tail of Audio-0 are in the same TS packet; the header of Audio-2 and the tail of Audio 1 are in the same TS packet, and the like.

It should be obvious that, in the related art, in encoding and outputting the TS packets, a plurality of video TS packets split from a plurality of consecutive video PES packets are consecutively output, followed by consecutively outputting a plurality of audio TS packets split from the same audio PES packet, and thus, the plurality of video PES and one audio PES are alternately output. Due to the video screen and the audio should be played simultaneously in playing the video, a larger block of data needs to be transmitted to begin playing in the case that the audio ES data are block piled-up.

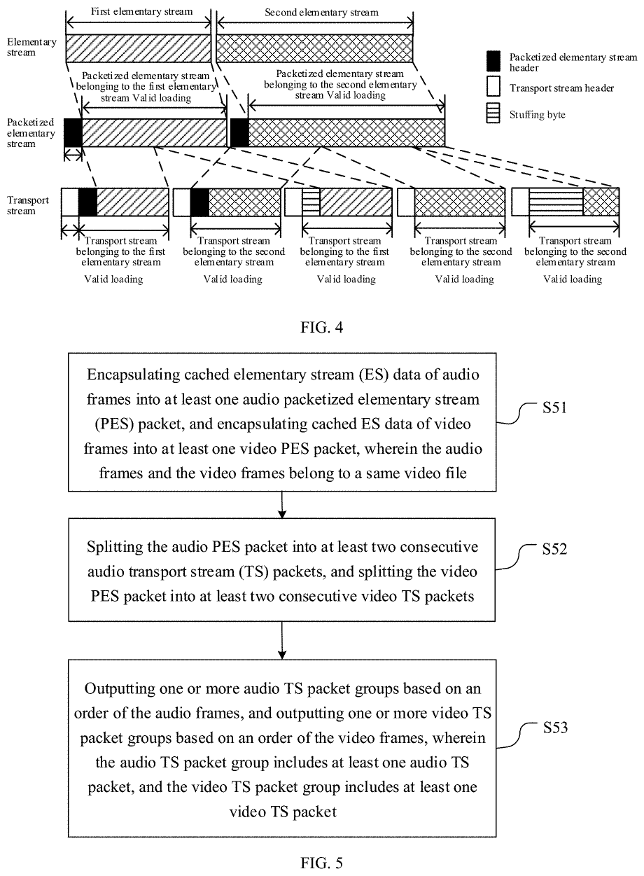

Accordingly, the embodiments of the present disclosure provide a method for encoding audio and video data, and an electronic device. Time division multiplexing refers to that the TS packets split from the same PES packet are not necessary to be physically consecutive, TS packets belonging to different ES streams may be alternately arranged. As shown in FIG. 4. FIG. 4 is a schematic diagram of a time division multiplexing according to an embodiment of the present disclosure, and a first ES stream and a second ES stream are shown in FIG. 4. A white block portion in the figure represents a TS packet header, a packet identifier (PID) field in the TS Header may be used to distinguish the ES stream to which the TS packet belongs, and a part of the TS packets belonging to the first ES stream and a part of the TS packets belonging to the second ES stream are alternately arranged. In the embodiments of the present disclosure, based on the time division multiplexing of the MPEG-TS stream when transmitting the multiplexed audio and video data, in the process of encoding audio and video data, at least one video TS packet is inserted between part or all of the audio TS packets split from the same audio PES packet, and at least one audio TS packet is inserted between part or all of the video TS packets split from the different video PES packets, the interleaving of the audio and video data is achieved in a smaller unit. Thus, interleaving of audio and video data can be achieved in a smaller unit, and a smaller block of data needs to be transmitted, thereby reducing stutter and delay in online on-demand.

For clear understanding, the technical solutions in the present disclosure are further described hereinafter in conjunction with the accompanying drawings.

FIG. 5 is a flowchart of a method for encoding audio and video data according to an embodiment. As shown in FIG. 5, the method includes processes S51 to S53.

In S51, cached elementary stream (ES) data of audio frames is encapsulated into at least one audio packetized elementary stream (PES) packet, and cached ES data of video frames is encapsulated into at least one video PES packet, wherein the audio frames and the video frames belong to a same video file.

In S52, the audio PES packet is split into at least two consecutive audio transport stream (TS) packets, and the video PES packet is split into at least two consecutive video TS packets.

In S53, one or more audio TS packet groups including at least one audio TS packet are output based on an order of the one or more audio frames, and one or more video TS packet groups including at least one video TS packet are output based on an order of the one or more video frames.

In an output order of the one or more audio TS packet groups and the one or more video TS packet groups, at least one of the one or more video TS packet groups is present between the audio TS packet groups belonging to a same audio PES packet, and at least one of the one or more audio TS packet groups is present between the video TS packet groups belonging to different video PES packets. At least one of the one or more video TS packet groups refer to one of the one or more video TS packet group or more of the one or more video TS packet groups, and at least one of the one or more audio TS packet groups refer to one of the one or more audio TS packet group or more of the one or more audio TS packet groups.

It should be noted that the embodiments of the present disclosure do not specifically limit that in the output order of the audio TS packet groups and the video TS packet groups, whether at least one video TS packet group is present between the audio TS packet groups split from different audio PES packets, and whether at least one audio TS packet group is present between the video TS packet groups split from the same video PES packet, which may be depended on the size of the PES packets in the actual case.

In the method for encoding audio and video data described above, at least one video TS packet group is inserted between audio TS packet groups split from the same PES packet of PES packets, and at least one audio TS packet group is inserted between part or all of the video TS packets split from different video PES packets. Thus, when the audio TS packets are output, the audio TS packets split from the same audio PES packet are not output consecutively because at least one video TS packet is inserted; and the video TS packets split from the different video PES packets are not output consecutively because at least one audio TS packet is inserted. At least one video TS packet group refers to one or more video TS packet groups, and at least one audio TS packet group refers to one or more audio TS packet groups. Compared with consecutive output of the audio TS packets split from the same audio PES packet and consecutive output of the video TS packets split from the different video PES packets in the related art, the method in the embodiments of the present disclosure encodes the audio and video TS packet in a smaller unit, and thus, in an on-demand scenario, it is not necessary to wait to download a larger data block, thereby reducing the delay and stutter of online play.

In some embodiments, prior to encapsulating the cached ES data of audio frames into at least one audio PES packet, and encapsulating the cached ES data of video frames into at least one video PES packet, the ES data of audio frames and the ES data of video frames input into the audio and video encoder are cached within a reference unit time period. At least one video PES packet group refers to one video PES packet group or more video PES packet groups, and at least one audio PES packet group refers to one audio TS packet group or more audio TS packet groups.

In some embodiments, a cache duration is set, denoted as cache_duration, and the cache_duration is a reference unit time period. When receives the ES data of audio frames and the ES data of video frames in the cache_duration, a MPEG-TS encoder does not immediately encode but cache, and the MPEG-TS encoder immediately performs cache code refresh operation once the length of the cache data exceeds the cache_duration.

For example, the cache_duration is 1 second, the ES data of 0^{th} to 2^{nd} frames of video frames and the ES data of 0^{th} to 2^{nd} frames of audio frames are cached within 0^{th} to 1^{st} second.

The cache code refresh operation refers to encoding and outputting the ES data of three frames of audio frames and the three frames of video frames cached within the 1 second, and caching the ES data within the next cache_duration.

In some embodiments, when the cached ES data of video frames is encapsulated into at least one video PES packet, the cached ES data of one frame of video frame is encapsulated into the video PES packet.

For example, the ES data of video frames cached within the reference unit time period is encapsulated into the video PES packet in the unit of frames, ES data of one frame of video frame is encapsulated into one video PES packet. Thus, the ES data of the 0^{th} frame of video frame is encapsulated into a video PES packet 1, the ES data of the 1^{st} frame of video frame is encapsulated into a video PES packet 2, and the ES data of the 2^{nd} frame of video frame is encapsulated into a video PES packet 3.

In some embodiments, the cached ES data of audio frames is encapsulated into at least one audio PES packet, and the cached at least ES data of one frame of audio frame is encapsulated into the audio PES packet.

For example, the ES data of audio frames cached within the reference unit time period is also encapsulated into the audio PES packet in the unit of frames, the ES data of one frame of audio frame is encapsulated into one audio PES packet. Thus, the ES data of the 0^{th} frame of audio frame is encapsulated into an audio PES packet 1, the ES data of the 1^{st} frame of audio frame is encapsulated into an audio PES packet 2, and the ES data of the 2^{nd} frame of audio frame is encapsulated into an audio PES packet 3.

In some embodiments. ES data of a plurality of frames of audio frames is merged and encapsulated into one audio PES packet to reduce the padding of valid bytes and improve the utilization of channel transmission. For example, the ES data of the 0^{th} to 2^{nd} frames audio frames is encapsulated into audio PES packet 4.

In some embodiments, the ES data of the 0^{th} frame of audio frame is encapsulated into an audio PES packet 5, the ES data of the 1^{st} to 2^{nd} frames of audio frames are encapsulated into an audio PES packet 6; or, the ES data of the 0^{th} to 1^{st} frames of audio frames are encapsulated into an audio PES packet 7, and the ES data of the 2^{nd} frame of audio frame is encapsulated into an audio PES packet 8. Thus, the padding of valid bytes compared with the fashion in which the ES data of one frame of audio frame is encapsulated into an audio PES packet.

Detailed description is shown hereinafter by taking the ES data of video frames being encapsulated into the video PES packet in the unit of frames, and the ES data of the plurality of frames of audio frames being encapsulated into the same audio PES packets into an example.

In the embodiments of the present disclosure, upon acquiring the audio PES packet and the video PES packet by encapsulating the cached ES data of audio frames and ES data of video frames, the audio PES packet needs to be split into the audio TS packets, and the video PES packet needs to be split into the video TS packets.

In some embodiments, the audio PES packet is split into at least two consecutive audio TS packets, and the video PES packet is split into at least two consecutive video TS packets.

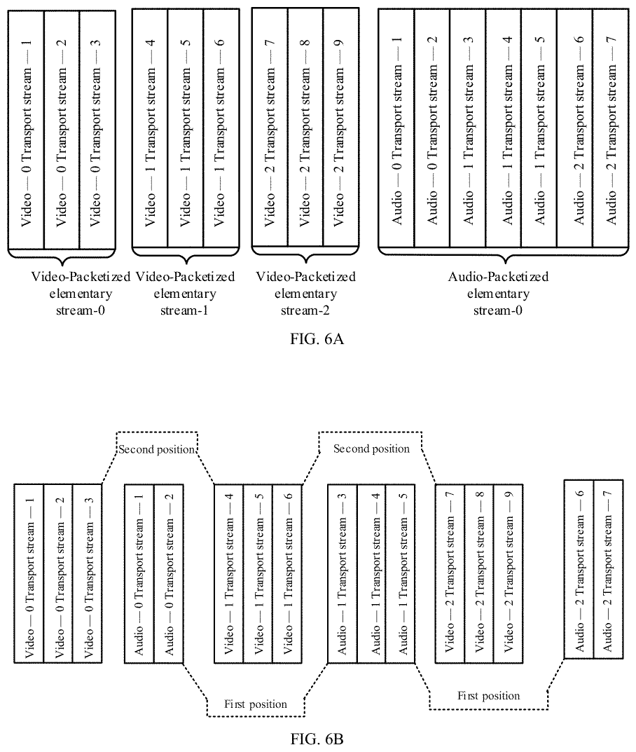

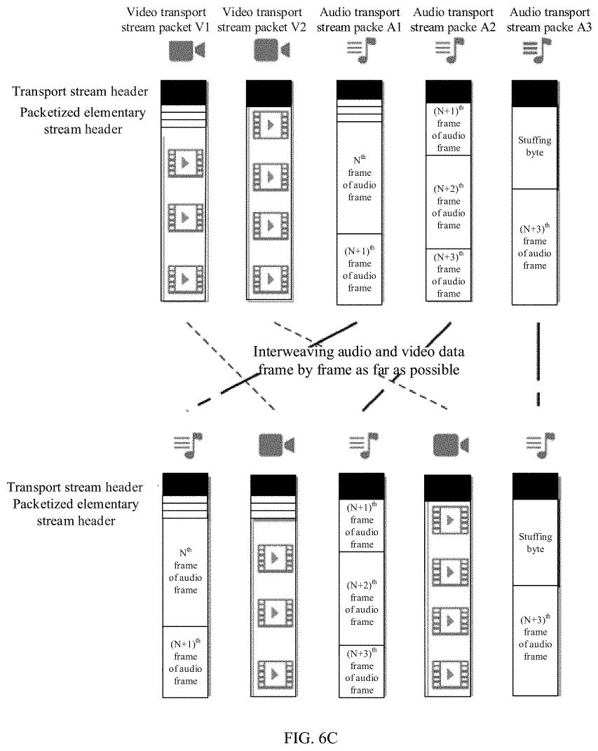

As shown in FIG. 6A, the video PES packets Video-PES-0 to Video-PES-2 are split into three video TS packets, i.e., video TS packets 1 to 9, which can be referred to Vdeio-0 TS-1 to Vdeio-2 TS-9 shown in FIG. 6A; the audio PES packet Audio-PES-0 is split into 7 audio TS packets, i.e., audio TS packets 1 to 7, wherein the TS packets of the 0^{th} to 2^{nd} frames of audio frames are audio TS packets 1 to 2, audio TS packets 3 to 5, and audio TS packets 6 to 7, which can be referred to Audio-0 TS-1 to Audio-2 TS-7 shown in FIG. 6A.

In the output order of the audio TS packet groups and the video TS packet groups according to the embodiments of the present disclosure, at least one video TS packet group is present between the audio TS packet groups belonging to the same audio PES packet, and at least one audio TS packet group is present between the video TS packet groups belonging to different video PES packets.

In some embodiments, the position between audio TS packet groups belonging to the same audio PES packet is referred to as a first position, and at least one video TS packet group is present between the audio TS packet groups belonging to the same audio PES packet. That is, at least one video TS packet group is present in pail or all of the first positions between audio TS packet groups belonging to the same audio PES packet.

Similarly, the position between video TS packet groups belonging to the different video PES packets is referred to as a second position, and at least one audio TS packet group is present in part or all of the second positions between video TS packet groups belonging to the different video PES packets.

One audio TS packet group includes one audio TS packet, or a plurality of audio TS packets. Likewise, one video TS packet group includes one video TS packet, or a plurality of video TS packets.

As shown in FIG. 6A, in the case that one audio TS packet group includes one audio TS packet, the first position refers to the position between the audio TS packet groups split from the same audio PES packet, i.e., the position between the 7 audio TS packets split from the Audio-PES-0. For example, the position between the audio TS packet 1 and the audio TS packet 2, the position between the audio TS packet 2 and the audio TS packet 3, the position between the audio TS packet 3 and the audio TS packet 4, the position between the audio TS packet 4 and the audio TS packet 5, the position between the audio TS packet 5 and the audio TS packet 6, and the position between the audio TS packet 6 and the audio TS packet 7. Part or all of the first position refers to part or all of the six positions described above.

In the case that one audio TS packet group includes at least two audio TS packets, the Audio-PES-0 is taken as an example, wherein the audio TS packets 1 to 2 are a group, the audio TS packets 3 to 5 are a group, and the audio TS packets 6 to 7 are a group. The first position refers to the position between the audio TS packet 2 and the audio TS packet 3, and the position between the audio TS packets 5 and the audio TS packets 6. Part or all of the first position refers to part or all of the 2 positions described above.

Similarly, as still shown in FIG. 6A, the second position refers to the position between the video TS packets split from different video PES packets, i.e., the position between Video-PES-0, Video-PES-1, and Video-PES-2. For example, the position between the video TS packet 3 and the video TS packet 4, the position between the video TS packet 6 and the video TS packet 7. Part or all of the second position refers to part or all of the two positions described above. The next video TS packet group includes one or at least two video TS packets.

In the embodiment of the present disclosure, when the audio TS packets are output based on the order of the audio frames, and the video TS packets are output based on the order of the video frames, in an output order of the audio TS packets and the video TS packets, at least one video TS packet group is present at part or all of the first positions, or at least one audio TS packet group is present at part or all of the second positions.

For example, the video TS packets 1 to 3 of the 0^{th} frame of video frame are output first. The audio TS packets 1 to 2 of the 0^{th} frame of audio frame are inserted at the second position between the video TS packet 3 and the video TS packet 4. The video TS packets 4 to 5 of the 1^{st} frame of video frame are inserted at the first position between the audio TS packet 2 and the audio TS packet 3. The audio TS packets 3 to 5 of the 1^{st} frame of audio frame are inserted at the second position between the video TS packet 6 and the video TS packet 7. The video TS packets 7 to 9 of the 2^{nd} frame of video frame are inserted at the first position between the audio TS packet 5 and the audio TS packet 6. The audio TS packets 6 to 7 of the 2^{nd} frame of audio frame are eventually output after the video TS packet 9, as shown in FIG. 6B.

The above-described embodiment illustrates an embodiment in which at least one video TS packet is present at the first position, and at least one audio TS packet is present at the second position, which is merely an example, and other fashions of outputting audio TS packets and video TS packets based on the output order defined in the embodiments of the present disclosure are also applicable to the embodiments of the present disclosure, which is not illustrated.

When the TS packets are grouped, in some embodiments, the audio TS packets split from the same audio PES packet are organized into at least two audio TS packet groups; and/or the video TS packets split from the same video PES packet are organized into one video TS packet group.

For example, during grouping of the audio TS packets, taking the audio PES packet 4 as an example, seven audio TS packets are included in the audio PES packet 4, and the seven audio TS packets organized into two audio TS packet groups. One of the two audio TS packet groups includes the audio TS packets 1 to 4, and the other includes the audio TS packets 5 to 7.

When the video TS packets are grouped, the video PES packets 1 to 3 are taken as an example, the video TS packets 1 to 3 split from the video PES packet 1 are organized into one video TS packet group, the video TS packets 4 to 6 split from the video PES packet 2 are organized into one video TS packet group, and the video TS packets 7 to 9 split from the video PES packet 3 are organized into one video TS packet group.

In some embodiments, the at least two consecutive audio TS packets organized within the present reference unit time period are organized in the following fashion.

A plurality of rounds of grouping are performed on the split audio TS packets. Each round of grouping is to select the audio TS packets, whose DTSs are minimum, from currently ungrouped audio TS packets, and organize the selected audio TS packets into a group. The DTSs corresponding to the audio TS packets are a minimum audio frame DTS in the audio frame DTSs corresponding to the ES data of audio frames in the audio TS packets.

In the grouping, the plurality of audio TS packet groups are acquired by performing, based on the audio frame DTSs corresponding to the ES data of audio frames, the plurality of rounds of grouping on the split audio TS packets.

It is noted that the audio TS packets split from the same audio PES packet can be organized into at least two audio TS packet groups in the above fashion.

The audio TS packets 1 to 7 shown in FIG. 6A is still taken as an example to illustrate the process of the plurality of rounds of grouping.

For example, the currently ungrouped audio TS packets are the audio TS packets 1 to 7, the audio TS packets 1 to 2 correspond to the 0^{th} frame of audio frame, and DTS is equal to 0; the audio TS packets 3 to 5 correspond to the 1^{st} frame of audio frame, and DTS is equal to 0.3; the audio TS packets 6 to 7 correspond to the 2^{nd} frame of audio frame, and DTS is equal to 0.7.

In the first round of grouping, the currently ungrouped audio TS packets includes 7 audio TS packets, wherein audio TS packets, whose DTSs are minimum, are the audio TS packets 1 to 2, and the audio TS packets 1 to 2 are organized into the audio TS packets group 1. In the second round of grouping, the currently ungrouped audio TS packets includes five audio TS packets, wherein audio TS packets, whose DTSs are minimum, are the audio TS packets 3 to 5, and the audio TS packets 3 to 5 are organized into the audio TS packets group 2. In the third round of grouping, the currently ungrouped audio TS packets includes 2 audio TS packets, wherein audio TS packets, whose DTSs are minimum, are the audio TS packets 6 to 7, the audio TS packets 6 to 7 are divided into the audio TS packets group 3, and the grouping is completed.

It is noted that the DTS of the TS packet is the minimum DTS in the DTS of the plurality of frames of audio frames in the case that the audio TS packet includes the plurality of frames of ES data.

For example, as shown in FIG. 6C, two video TS packets V1 and V2 and three audio TS packets A1, A2. A3 are included. The audio TS packet A1 includes the ES data of the N^{th} frame of audio frame and part of the ES data of the (N+1)^{th} frame of audio frame; the audio TS packet A2 includes part of the ES data of the (N+1)^{th} frame of audio frame, the ES data of the of the (N+2)^{th} frame of audio frame, and part of the ES data of the (N+2)^{th} frame of audio frame.

The audio TS packet A1 is taken as an example, the DTSs corresponding to the audio TS packets are the minimum DTS in the DTS of the N^{th} frame of audio frame (Audio-N) and the DTS of the (N+1)^{th} frame of audio frame (Audio-N+1), that is, the DTS of the N^{th} frame of audio frame is the DTS corresponding to the audio TS packet A1. Taking the audio TS packet A2 as an example, the DTSs corresponding to the audio TS packets are the minimum DTS in the DTS of the (N+1)^{th} frame of audio frame, the DTS of the (N+2)^{th} frame of audio frame (Audio-N+2) and the DTS of the (N+3)^{th} frame of audio frame (Audio-N+3), that is, the DTS of the (N+1)^{th} frame of audio frame is the DTS corresponding to the audio TS packet A2. For the audio TS packet A3, as the audio TS packet A3 merely includes the ES data of the (N+3)^{th} frame of audio frame, the corresponding DTS is the DTS of the (N+3)^{th} frame of audio frame.

In some embodiments, the at least two consecutive video TS packets organized within the present reference unit time period are organized in the following fashion.

A plurality of rounds of grouping are performed on the split video TS packet. Each round of grouping is to select video TS packets, whose DTSs are minimum, from currently ungrouped video TS packets and organize the selected video TS packets into a group. The DTSs corresponding to the video TS packets are a minimum video frame DTS in the video frame DTSs corresponding to the ES data of video frames in the video TS packets.

In the above grouping, the plurality of video TS packet groups are acquired by performing, based on the video frame DTSs corresponding to the ES data of video frames, the plurality of rounds of grouping on the split video TS packets.

It is noted that the video TS packets split from the same video PES packet can be organized into at least two video TS packet groups in the above fashion.

The video TS packets 1 to 9 are still taken as an example to illustrate the process of the plurality of rounds of grouping.

For example, the currently ungrouped video TS packets are the video TS packets 1 to 9, the video TS packets 1 to 3 correspond to the 0^{th} frame of video frame, and DTS is equal to 0; the video TS packets 4 to 6 correspond to the 1^{st} frame of video frame, and DTS is equal to 0.3; the video TS packets 7 to 9 correspond to the 2^{nd} frame of video frame, and DTS is equal to 0.7.

In the first round of grouping, the currently ungrouped video TS packets include 9 video TS packets, wherein the video TS packets, whose DTSs are minimum, are the video TS packets 1 to 3, and the video TS packets 1 to 3 are organized into the video TS packets group 1. In the second round of grouping, the currently ungrouped video TS packets include 6 video TS packets, wherein the video TS packets, whose DTSs are minimum, are the video TS packets 4 to 6, and the video TS packets 4 to 6 are organized into the video TS packets group 2. In the third round of grouping, the currently ungrouped video TS packets include 3 video TS packets, wherein the video TS packets, whose DTSs are minimum, are the video TS packets 7 to 9, the video TS packets 7 to 9 are organized into the video TS packets group 3, and the grouping is completed.

It should be noted that, in the embodiments of the present disclosure, the fashion in which the video ES data is encapsulated into the video PES packet in the unit of frames is mainly described, such that the case in which one video ES packet includes the ES data of a plurality of frames of video frames may not exists.

As shown in FIG. 6C. FIG. 6C is a schematic diagram of outputting an audio TS packet group based on an order of the audio frames, and outputting a video TS packet group based on an order of the video frames according to an embodiment of the present disclosure. The plurality of frames of audio frames are encapsulated into one audio PES packet, and then the audio PES packets are split into three audio TS packets. The three audio TS packets are organized into three groups of audio TS packet groups, which are output in conjunction with the video TS packet groups within corresponding time period, and one video TS packet group includes one video TS packet.

In the embodiments of the present disclosure, when outputting the audio TS packets and the video TS packets in the unit of the TS packet, there are mainly two output fashion, which are described hereinafter.

In the first output fashion, the audio TS packet groups and the video TS packet groups are output alternately based on the order of the audio frames and the order of the video frames in response to performing the plurality of rounds of grouping on the audio TS packets and the video TS packets.

In some embodiments, the output order of the audio TS packet groups and the video TS packet groups is determined in response to performing the plurality of rounds of grouping on the audio TS packets and the video TS packets, and the audio TS packet groups and the video TS packet groups are output based on the determined output order.

The output order is that the audio TS packet groups are output in an ascending order of the DTSs corresponding to the audio TS packets in the audio TS packet groups, and the video TS packet groups are output in an ascending order of the DTSs corresponding to the video TS packets in the video TS packet groups, and one group of the audio TS packet group and one group of video TS packet group are output alternately.

For example, taking the scenario of performing three rounds of grouping on the audio TS packets 1 to 7 and performing three rounds of grouping on the video TS packets 1 to 9 in the embodiments described above as an example, the six TS packet groups acquired from the six rounds of grouping are output base on the DTS size in response of completing the 6 groupings.

In an alternate output fashion, the video TS packet group 1 is output first, and then the audio data packet group 1, the video TS packet group 2, the audio data packet group 2, the video TS packet group 3, and the audio data packet group 3 are output successively.

The TS packets output in the unit of the TS packet group is equivalent to outputting the TS packets of a TS packet group in a sequential order. Thus, when the TS packets are output in the output order of the TS packet group, the output order of the TS packets is the video TS packet 1, the video TS packet 2, the video TS packet 3, the audio TS packet 1, the audio TS packet 2, the video TS packet 4, the video TS packet 5, the video TS packet 6, the audio TS packet 3, the audio TS packet 4, the audio TS packet 5, the video TS packet 7, the video TS packet 8, the video TS packet 9, the audio TS packet 6, and the audio TS packet 7.

In another alternate output fashion, the audio TS packet group 1 is output first, and then the video data packet group 1, the audio TS packet group 2, the video data packet group 2, the audio TS packet group 3, and the video data packet group 3 are output successively.

When the TS packets are outputted based on the above output order of the TS packet group, the output order of the TS packets is the audio TS packet 1, the audio TS packet 2, the video TS packet 1, the video TS packet 2, the video TS packet 3, the audio TS packet 3, the audio TS packet 4, the audio TS packet 5, the video TS packet 4, the video TS packet 5, the video TS packet 6, the audio TS packet 6, the audio TS packet 7, the video TS packet 7, the video TS packet 8, the video TS packet 9.

In the second output fashion, the grouping is performed, and simultaneously, the audio TS packet groups and the video TS packet groups are output based on the order of the audio frames and the order of the video frames in the process of performing the plurality of rounds of grouping on the audio TS packets.

In some embodiments, outputting the audio TS packets and the video TS packets in the unit of TS packet groups includes: outputting the grouped audio TS packet group in response to performing at least one round of grouping on the audio TS packets in the process of performing the plurality of rounds of grouping on the audio TS packets; and outputting the grouped video TS packet groups in response to performing at least one round of grouping on the video TS packets in the process of performing the plurality of rounds of grouping on the video TS packets; wherein one group of the audio TS packet group and one group of video TS packet group are output alternately.

For example, the case of the 3 groupings on the audio TS packets 1 to 7 and the 3 groupings on the video TS packets 1 to 9 in the embodiments described above is taken as an example, assuming that the audio TS packet groups acquired from the round of grouping are output in response to performing one round of grouping on the audio TS packets, and the video TS packet groups obtained from the round of grouping are output in response to performing one round of grouping on the video TS packets.

An alternate output fashion is: to output the audio TS packet 1 and the audio TS packet 2 in response to performing the first round of grouping on the audio TS packets; to output the video TS packet 1, the video TS packet 2, the video TS packet 3 in response to performing the first round of grouping on the audio TS packets; to output the audio TS packet 3, the audio TS packet 4, the audio TS packet 5 in response to performing the second round of grouping on the audio TS packet; to output the video TS packet 4, the video TS packet 5, the video TS packet 6 in response to performing the second round of grouping on the video TS packets; to output the audio TS packet 6, the audio TS packet 7 in response to performing the third round of grouping on the audio TS packet; to output the video TS packet 7, the video TS packet 8, the video TS packet 9 in response to performing the third round of grouping on the video TS packets.

Another alternate output fashion is: to output the video TS packet 1, the video TS packet 2, the video TS packet 3 in response to performing the first round of grouping on the audio TS packets; to output the audio TS packet 1 and the audio TS packet 2 in response to performing the first round of grouping on the audio TS packets; to output the video TS packet 4, the video TS packet 5, the video TS packet 6 in response to performing the second round of grouping on the video TS packets; to output the audio TS packet 3, the audio TS packet 4, the audio TS packet 5 in response to performing the second round of grouping on the audio TS packets; to output the video TS packet 7, the video TS packet 8, the video TS packet 9 in response to performing the third round of grouping on the video TS packets; to output the audio TS packet 6, the audio TS packet 7 in response to performing the third round of grouping on the audio TS packets.

In the case that the audio TS packets are grouped and the video TS packets are grouped, another embodiment is that a first round of grouping is performed on the audio TS packets and a first round grouping is performed on the video TS packets, and the audio TS packet 1, the audio TS packet 2, the video TS packet 1, the video TS packet 2, the video TS packet 3 are output (also as a sequence of the video TS packet 1, the video TS packet 2, the video TS packet 3, the audio TS packet 1, the audio TS packet 2) in response to performing the first round of grouping on the audio TS packet and the video TS packet; a second round of grouping is performed on the audio TS packet, and a second round of grouping is performed on the video TS packets, the TS packet group obtained from grouping is output; a third round of grouping is performed on the audio TS packets, and a third round of grouping is performed on the video TS packets, the TS packet group obtained from grouping is output.

It should be noted that the alternate output fashion of the audio TS packet groups and the video TS packet groups set forth in the above embodiments are merely examples, and any alternate output fashion of the audio TS packet groups and the video TS packet groups satisfying the above conditions may be used in the present disclosure.

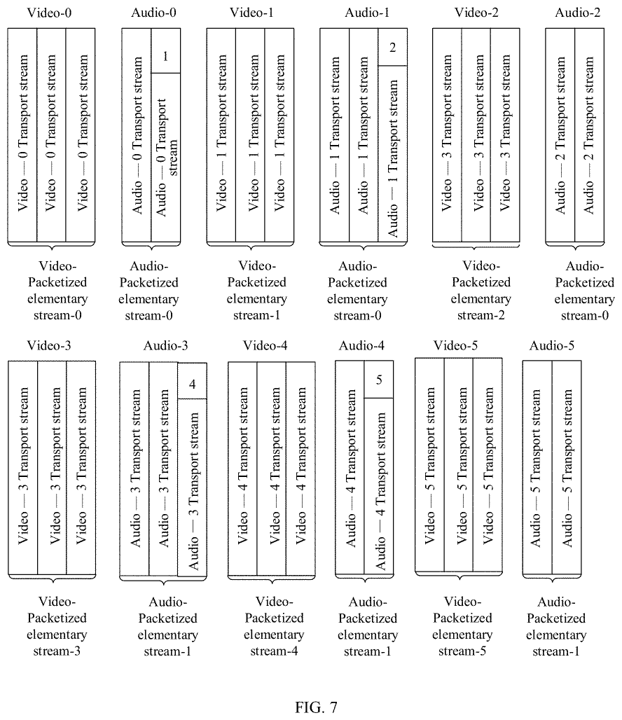

As shown in FIG. 7. FIG. 7 is a schematic diagram of alternately outputting an audio TS packet groups and a video TS packet groups according to an embodiment of the present disclosure, which is an embodiment obtained by encoding the audio and video data shown in FIG. 3 according to the method for encoding audio and video data according to the embodiments of the present disclosure. Assuming that the ES data of three frames of video frames and the ES data of the three frames of audio frames are cached within the first reference unit time period, i.e., Video-0 to Video-2 and Audio-0 to Audio-2, then the ES data of Video-0 to Video-2 are encapsulated into three groups of video PES packets from Video-PES-0 to Video-PES-12, and the video PES packet is split into three video TS packets, and the three video TS packets are organized into three groups of video TS packet groups; the ES data of Audio-0 to Audio-2 are encapsulated into one audio PES packet of Audio-PES-0, the audio PES packet is split into seven audio TS packets, and the seven audio TS packets are organized into three groups of audio TS packet groups frame by frame.

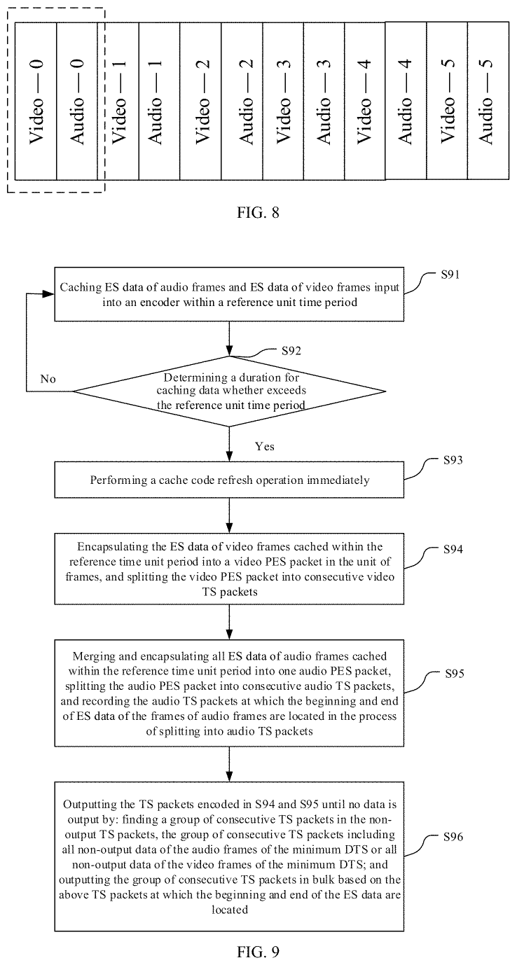

In the case that the six TS packet groups obtained from the ES data within the first reference unit time period are output in the fashion shown in FIG. 7, the ES data of three frames of video frames and the ES data of three frames of audio frames are cached within the second reference unit time period, i.e., Video-3 to Video-5 and Audio-3 to Audio-5. The ES data of Video-3 to Video-5 are encapsulated into three video PES packets from Video-PES-3 to Video-PES-5, and the video PES packet is split into three video TS packets, and the three video TS packets are organized into three groups of video TS packet groups; the ES data of Audio-3 to Audio-5 are encapsulated into one audio PES packet of Audio-PES-1, the audio PES packet is split into seven audio TS packets, and the seven TS packets are organized into three groups of audio TS packet groups frame by frame. After output with the fashion in FIG. 7, the 12 TS packet groups are output in a sequence of the Vedio-0, the Audio-0, Video-1. Audio-1, Video-2. Audio-2, Video-3, Audio-3, Video-4, Audio-4, Video-5, and Audio-5. As shown in FIG. 8, in the case of an online on-demand scenario. Video-0 and Audio-0 are merely transmitted to start to play, which effectively reduces the delay and stutter of online play.

It is noted that in the embodiments of the present disclosure, other parameters but DTS for distinguishing audio frames or video frames can also be used to determine the output order, such as frame number, N^{th} frame, (N+1)^{th} frame, and the like.

FIG. 9 is a flowchart of a method for encoding audio and video data in a fashion of grouping and outputting simultaneous according to an embodiment. As shown in FIG. 9, the method includes processes S91 to S96:

In S91, ES data of audio frames and ES data of video frames input into a MPEG-TS encoder are cached within a reference unit time period cache_duration.

In S92, a duration for caching data is determined whether exceeds the reference unit time period cache_duration. S93 is performed where the duration for caching data exceeds the cache_duration, and the process is returned to S91 where the duration for caching data does not exceed the cache_duration.

In S93, a cache code refresh operation is performed immediately.

In S94, the ES data of video frames cached within the reference unit time period is encapsulated into a video PES packet in the unit of frames, and then the video PES packet is split into consecutive video TS packets.

In S95, all ES data of audio frames cached within the cache unit time period are merged and encapsulated into one audio PES packet, and then the audio PES packet is split into consecutive audio TS packets, and the audio TS packets at which the beginning and end of ES data of each frame of audio frame are located are recorded in the process of splitting into audio TS packets.

In S96, the TS packets encoded in S94 and S95 are output until no data is output by: finding a group of consecutive TS packets in the non-output TS packets, the group of consecutive TS packets including all non-output data of the audio frames of the minimum DTS or all non-output data of the video frames of the minimum DTS; and the group of consecutive TS packets is output in bulk based on the above TS packets at which the beginning and end of the ES data are located.

In some embodiments, after all TS packets are grouped in S96, and output in the ascending order of the DTSs corresponding to the TS packets. Thus, all TS packets can be output in response of completing a plurality of rounds of grouping.

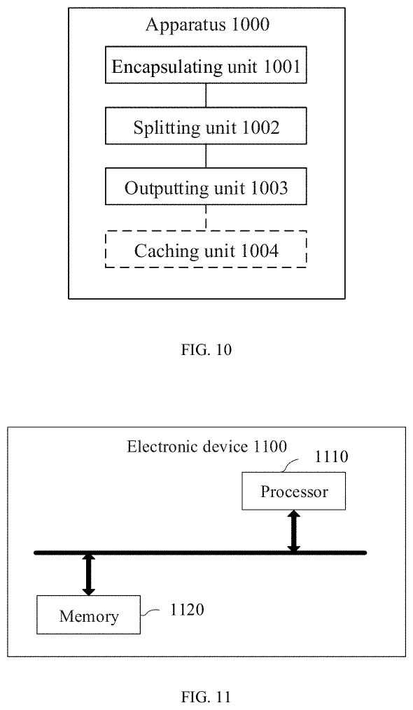

FIG. 10 is a block diagram of an apparatus for encoding audio and video data according to an embodiment of the present disclosure. Referring to FIG. 10, the apparatus 1000 includes a packaging unit 1001, a splitting unit 1002, and an outputting unit 1003.

The packaging unit 1001 is configured to pack cached ES data of audio frames into at least one audio PES packet, and pack cached ES data of video frames into at least one video PES packet, wherein the audio frames and the video frames belong to the same video file.

The splitting unit 1002 is configured to split the audio PES packet into at least two consecutive audio TS packets, and splitting the video PES packet into at least two consecutive video TS packets.

The outputting unit 1003 is configured to output one or more audio TS packet groups based on an order of the audio frames, and outputting one or more video TS packet groups based on an order of the video frames, wherein the audio TS packet group includes at least one audio TS packet, and the video TS packet group includes at least one video TS packet.

In an output order of the one or more audio TS packet groups and the one or more video TS packet groups, at least one of the one or more video TS packet groups is present between the audio TS packet groups belonging to a same audio PES packet, and at least one of the one or more audio TS packet groups is present between the video TS packet groups belonging to different video PES packets.

In some embodiments, the splitting unit 1002 is configured to:

organize audio TS packets split from the same audio PES packet into at least two audio TS packet groups; and

organize video TS packets split from the same video PES packet into one video TS packet group.

In some embodiments, the outputting unit 1003 is configured to:

acquire a plurality of audio TS packet groups by performing, based on audio frame decoding timestamps (DTSs) corresponding to the ES data of the audio frames, a plurality of rounds of grouping on the split audio TS packets; and

acquire a plurality of video TS packet groups by performing, based on video frame DTSs corresponding to the ES data of the video frames, a plurality of rounds of grouping on the split video TS packets.

In some embodiments, the outputting unit 1003 is configured to:

select audio TS packets, whose DTSs are minimum, from currently ungrouped audio TS packets, wherein the DTSs corresponding to the audio TS packets are a minimum audio frame DTS in the audio frame DTSs corresponding to the ES data of the audio frames in the audio TS packets; and

organize the selected audio TS packets into a group.

In some embodiments, the outputting unit 1003 is configured to:

select video TS packets, whose DTSs are minimum, from currently ungrouped video TS packets, wherein the DTSs of the video TS packets are a minimum video frame DTS in the video frame DTSs corresponding to the ES data of the video frames in the video TS packets; and

organize the selected video TS packets into a group.

In some embodiments, the outputting unit 1003 is configured to:

determine the output order of the one or more audio TS packet groups and the one or more video TS packet groups in response to performing the plurality of rounds of grouping on the audio TS packets and the video TS packets; and output the one or more audio TS packet groups and the one or more video TS packet groups based on the determined output order.

In some embodiments, the outputting unit 1003 is configured to:

output the one or more audio TS packet groups in an ascending order of the DTSs corresponding to the audio TS packets in the one or more audio TS packet groups, and output the one or more video TS packet groups in an ascending order of the DTSs corresponding to the video TS packets in the one or more video TS packet groups, wherein one of the one or more audio TS packet groups and one of the one or more video TS packet groups are output alternately.

In some embodiments, the outputting unit 1003 is configured to:

output one or more audio TS packet groups acquired each time at least one round of grouping is performed on the audio TS packets in the process of performing the plurality of rounds of grouping on the audio TS packets; and

output one or more video TS packet groups acquired each time at least one round of grouping is performed on the video TS packets in the process of performing the plurality of rounds of grouping on the video TS packets;

wherein one of the one or more audio TS packet groups and one of the one or more video TS packet groups are output alternately.

In some embodiments, the apparatus further includes:

a caching unit 1004, configured to cache the ES data of audio frames and the ES data of video frames input into the audio and video encoder within a reference unit time period.

For the apparatus in the embodiments described above, the specific implementation in which the various units perform the request has been described in detail in the embodiments of the method for encoding audio and video data, which is not described in detail herein.

FIG. 11 is a block diagram of an electronic device 1100 according to an embodiment of the present disclosure. The electronic device 1100 includes:

a processor 1110; and

a memory configured to store one or more instructions executable by the processor;

wherein the processor, when loading and executing the one or more instructions, is caused to perform:

encapsulating cached elementary stream (ES) data of audio frames into at least one audio packetized elementary stream (PES) packet, and encapsulating cached ES data of video frames into at least one video PES packet, wherein the audio frames and the video frames belong to a same video file;

splitting the audio PES packet into at least two consecutive audio transport stream (TS) packets, and splitting the video PES packet into at least two consecutive video TS packets; and

outputting one or more audio TS packet groups based on an order of the audio frames, and outputting one or more video TS packet groups based on an order of the video frames, wherein the audio TS packet group includes at least one audio TS packet, and the video TS packet group includes at least one video TS packet;

wherein in an output order of the one or more audio TS packet groups and the one or more video TS packet groups, at least one of the one or more video TS packet groups is present between the audio TS packet groups belonging to a same audio PES packet, and at least one of the one or more audio TS packet groups is present between the video TS packet groups belonging to different video PES packets.

In some embodiments, the processor 1110, when loading and executing the one or more instructions, is caused to perform:

organizing audio TS packets split from the same audio PES packet into at least two audio TS packet groups;

organizing video TS packets split from the same video PES packet into one video TS packet group.

In some embodiments, the processor 1110, when loading and executing the one or more instructions, is caused to perform:

acquiring a plurality of audio TS packet groups by performing, based on audio frame decoding timestamps (DTSs) corresponding to the ES data of the audio frames, a plurality of rounds of grouping on the split audio TS packets; and

organizing the video TS packets split from the same video PES packet into one video TS packet group includes:

acquiring a plurality of video TS packet groups by performing, based on video frame DTSs corresponding to the ES data of the video frames, a plurality of rounds of grouping on the split video TS packets.

In some embodiments, the processor 1110, when loading and executing the one or more instructions, is caused to perform:

selecting audio TS packets, whose DTSs are minimum, from currently ungrouped audio TS packets, wherein the DTSs corresponding to the audio TS packets are a minimum audio frame DTS in the audio frame DTSs corresponding to the ES data of the audio frames in the audio TS packets; and

organizing the selected audio TS packets into a group.

In some embodiments, the processor 1110, when loading and executing the one or more instructions, is caused to perform:

selecting video TS packets, whose DTSs are minimum, from currently ungrouped video TS packets, wherein the DTSs of the video TS packets are a minimum video frame DTS in the video frame DTSs corresponding to the ES data of the video frames in the video TS packets; and

organizing the selected video TS packets into a group.

In some embodiments, the processor 1110, when loading and executing the one or more instructions, is caused to perform:

determining the output order of the one or more audio TS packet groups and the one or more video TS packet groups in response to performing the plurality of rounds of grouping on the audio TS packets and the video TS packets; and output the one or more audio TS packet groups and the one or more video TS packet groups based on the determined output order.

In some embodiments, the processor 1110, when loading and executing the one or more instructions, is caused to perform:

outputting the one or more audio TS packet groups in an ascending order of the DTSs corresponding to the audio TS packets in the one or more audio TS packet groups, and outputting the one or more video TS packet groups in an ascending order of the DTSs corresponding to the video TS packets in the one or more video TS packet groups, wherein one of the one or more audio TS packet groups and one of the one or more video TS packet groups are output alternately.

In some embodiments, the processor 1110, when loading and executing the one or more instructions, is caused to perform:

outputting one or more audio TS packet groups acquired each time at least one round of grouping is performed on the audio TS packets in the process of performing the plurality of rounds of grouping on the audio TS packets; and

outputting one or more video TS packet groups acquired each time at least one round of grouping is performed on the video TS packets in the process of performing the plurality of rounds of grouping on the video TS packets;

wherein one of the one or more audio TS packet groups and one of the one or more video TS packet groups are output alternately.

In some embodiments, the processor 1110, when loading and executing the one or more instructions, is caused to perform:

caching the ES data of audio frames and the ES data of video frames input into the audio and video encoder within a reference unit time period.

An embodiment of the present disclosure further provides a storage medium storing one or more instructions therein, for example, a memory 1120 including one or more instructions therein. The one or more instructions, when loaded executed by the processor 1110 of the electronic device 1100, cause the electronic device 1100 to perform:

encapsulating cached elementary stream (ES) data of audio frames into at least one audio packetized elementary stream (PES) packet, and encapsulating cached ES data of video frames into at least one video PES packet, wherein the audio frames and the video frames belong to a same video file;

splitting the audio PES packet into at least two consecutive audio transport stream (TS) packets, and splitting the video PES packet into at least two consecutive video TS packets; and

outputting one or more audio TS packet groups based on an order of the audio frames, and outputting one or more video TS packet groups based on an order of the video frames, wherein the audio TS packet group includes at least one audio TS packet, and the video TS packet group includes at least one video TS packet;

wherein in an output order of the one or more audio TS packet groups and the one or more video TS packet groups, at least one of the one or more video TS packet groups is present between the audio TS packet groups belonging to a same audio PES packet, and at least one of the one or more audio TS packet groups is present between the video TS packet groups belonging to different video PES packets.

In some embodiments, the one or more instructions, when loaded and executed by the processor 1110 of the electronic device 1100, cause the electronic device 1100 to perform:

organizing audio TS packets split from the same audio PES packet into at least two audio TS packet groups; and;

organizing video TS packets split from the same video PES packet into one video TS packet group.

In some embodiments, the one or more instructions, when loaded executed by the processor 1110 of the electronic device 1100, cause the electronic device 1100 to perform:

acquiring a plurality of audio TS packet groups by performing, based on audio frame decoding timestamps (DTSs) corresponding to the ES data of the audio frames, a plurality of rounds of grouping on the split audio TS packets; and

organizing the video TS packets split from the same video PES packet into one video TS packet group includes:

acquiring a plurality of video TS packet groups by performing, based on video frame DTSs corresponding to the ES data of the video frames, a plurality of rounds of grouping on the split video TS packets.

In some embodiments, the one or more instructions, when loaded executed by the processor 1110 of the electronic device 1100, cause the electronic device 1100 to perform:

selecting audio TS packets, whose DTSs are minimum, from currently ungrouped audio TS packets, wherein the DTSs corresponding to the audio TS packets are a minimum audio frame DTS in the audio frame DTSs corresponding to the ES data of the audio frames in the audio TS packets; and

organizing the selected audio TS packets into a group.

In some embodiments, the one or more instructions, when loaded executed by the processor 1110 of the electronic device 1100, cause the electronic device 1100 to perform:

selecting video TS packets, whose DTSs are minimum, from currently ungrouped video TS packets, wherein the DTSs of the video TS packets are a minimum video frame DTS in the video frame DTSs corresponding to the ES data of the video frames in the video TS packets; and

organizing the selected video TS packets into a group.

In some embodiments, the one or more instructions, when loaded executed by the processor 1110 of the electronic device 1100, cause the electronic device 1100 to perform:

determining the output order of the one or more audio TS packet groups and the one or more video TS packet groups in response to performing the plurality of rounds of grouping on the audio TS packets and the video TS packets; and outputting the one or more audio TS packet groups and the one or more video TS packet groups based on the determined output order.

In some embodiments, the one or more instructions, when loaded executed by the processor 1110 of the electronic device 1100, cause the electronic device 1100 to perform:

outputting the one or more audio TS packet groups in an ascending order of the DTSs corresponding to the audio TS packets in the one or more audio TS packet groups, and outputting the one or more video TS packet groups in an ascending order of the DTSs corresponding to the video TS packets in the one or more video TS packet groups, wherein one of the one or more audio TS packet groups and one of the one or more video TS packet groups are output alternately.

In some embodiments, the one or more instructions, when loaded executed by the processor 1110 of the electronic device 1100, cause the electronic device 1100 to perform:

outputting one or more audio TS packet groups acquired each time at least one round of grouping is performed on the audio TS packets in the process of performing the plurality of rounds of grouping on the audio TS packets; and

outputting one or more video TS packet groups acquired each time at least one round of grouping is performed on the video TS packets in the process of performing the plurality of rounds of grouping on the video TS packets;

wherein one of the one or more audio TS packet groups and one of the one or more video TS packet groups are output alternately.

In some embodiments, the one or more instructions, when loaded executed by the processor 1110 of the electronic device 1100, cause the electronic device 1100 to perform:

caching the ES data of audio frames and the ES data of video frames input into the audio and video encoder within a reference unit time period.

Furthermore, in some embodiments, the storage medium is a non-transitory computer readable storage medium. e.g., the non-transitory computer readable storage medium is a read only memory (ROM), a random access memory (RAM), a CD-ROM, a magnetic tape, a floppy disk, an optical data storage device, and the like.

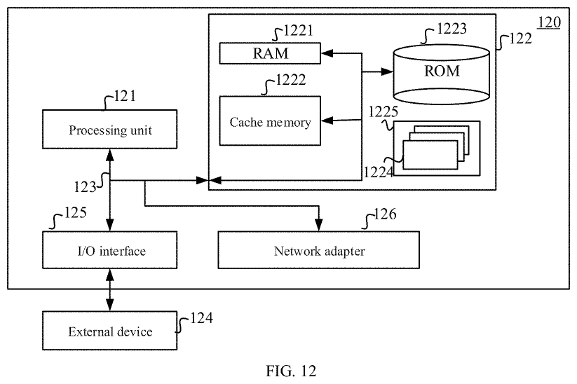

A processing device 120 according to an embodiment of the present disclosure is described below with reference to FIG. 12. The processing device 120 in FIG. 12 is merely an example and is not intended to limit the function and the use scope of the embodiments of the present disclosure.

As shown in FIG. 12, assemblies of the processing device 120 include, but are not limited to, at least one processing unit 121, at least one memory unit 122 described above, and a bus 123 connecting different system components (including the memory unit 122 and the processing unit 121).

The bus 123 represents one or more of several types of bus structures, and includes a memory bus or memory controller, a peripheral bus, a processor, or a local bus using any bus structure of a plurality of bus structures.

The memory unit 122 includes a volatile readable medium, such as a random access memory (RAM) 1221 and/or a cache memory 1222, and further includes a read only memory (ROM) 1223.

The memory unit 122 further includes a program/utility 1225 having a set (at least one) of program modules 1224. The program module 1224 includes, but is not limited to, an operating system, one or more application programs, other program module, and program data, and each or some combination of which may include an implementation of a network environment.

The processing device is 120 further communicated with one or more external devices 124 (e.g., a keyboard, a pointing device, etc.), and can be communicated with one or more devices through which a user can be interacted with the processing device 120, and/or can be communicated with any devices (e.g., a router, a modem, and the like) through which the processing device 120 can be communicated with one or more other processing devices. The communication is performed through an input/output (I/O) interface 125. Furthermore, the processing device 120 is further communicated with one or more networks (such as a local area network (LAN), a wide area network (WAN), and/or a public network (e.g., the Internet)) through a network adapter 126. As shown in FIG. 12, the network adapter 126 is communicated with other modules for processing device 120 through the bus 123. It should be understood that although not shown, other hardware and/or software modules, used in connection with the processing device 120, includes, but are not limited to, a microcode, a device driver, a redundant processor, an external disk drive array, a RAID system, a tape driver, and data archival storage systems and the like.

An embodiment of the present disclosure further provides a computer program product.

The computer program product, when loaded and run on an electronic device, causes the electronic device to perform:

encapsulating cached elementary stream (ES) data of audio frames into at least one audio packetized elementary stream (PES) packet, and encapsulating cached ES data of video frames into at least one video PES packet, wherein the audio frames and the video frames belong to a same video file;

splitting the audio PES packet into at least two consecutive audio transport stream (TS) packets, and splitting the video PES packet into at least two consecutive video TS packets; and

outputting one or more audio TS packet groups based on an order of the audio frames, and outputting one or more video TS packet groups based on an order of the video frames, wherein the audio TS packet group includes at least one audio TS packet, and the video TS packet group includes at least one video TS packet;

wherein in an output order of the one or more audio TS packet groups and the one or more video TS packet groups, at least one of the one or more video TS packet groups is present between the audio TS packet groups belonging to a same audio PES packet, and at least one of the one or more audio TS packet groups is present between the video TS packet groups belonging to different video PES packets.

In some embodiments, the computer program product, when loaded and run on the electronic device, causes the electronic device to perform:

organizing audio TS packets split from the same audio PES packet into at least two audio TS packet groups; and

organizing video TS packets split from the same video PES packet into one video TS packet group.

In some embodiments, the computer program product, when loaded and run on the electronic device, causes the electronic device to perform:

acquiring a plurality of audio TS packet groups by performing, based on audio frame decoding timestamps (DTSs) corresponding to the ES data of the audio frames, a plurality of rounds of grouping on the split audio TS packets; and

organizing the video TS packets split from the same video PES packet into one video TS packet group includes:

acquiring a plurality of video TS packet groups by performing, based on video frame DTSs corresponding to the ES data of the video frames, a plurality of rounds of grouping on the split video TS packets.

In some embodiments, the computer program product, when loaded and run on the electronic device, causes the electronic device to perform:

selecting audio TS packets, whose DTSs are minimum, from currently ungrouped audio TS packets, wherein the DTSs corresponding to the audio TS packets are a minimum audio frame DTS in the audio frame DTSs corresponding to the ES data of the audio frames in the audio TS packets; and

organizing the selected audio TS packets into a group.

In some embodiments, the computer program product, when loaded and run on the electronic device, causes the electronic device to perform:

selecting video TS packets, whose DTSs are minimum, from currently ungrouped video TS packets, wherein the DTSs of the video TS packets are a minimum video frame DTS in the video frame DTSs corresponding to the ES data of the video frames in the video TS packets; and

organizing the selected video TS packets into a group.

In some embodiments, the computer program product, when loaded and run on the electronic device, causes the electronic device to perform:

determining the output order of the one or more audio TS packet groups and the one or more video TS packet groups in response to performing the plurality of rounds of grouping on the audio TS packets and the video TS packets; and outputting the one or more audio TS packet groups and the one or more video TS packet groups based on the determined output order.

In some embodiments, the computer program product, when loaded and run on the electronic device, causes the electronic device to perform:

outputting the one or more audio TS packet groups in an ascending order of the DTSs corresponding to the audio TS packets in the one or more audio TS packet groups, and outputting the one or more video TS packet groups in an ascending order of the DTSs corresponding to the video TS packets in the one or more video TS packet groups, wherein one of the one or more audio TS packet groups and one of the one or more video TS packet groups are output alternately.

In some embodiments, the computer program product, when loaded and run on the electronic device, causes the electronic device to perform:

outputting one or more audio TS packet groups acquired each time at least one round of grouping is performed on the audio TS packets in the process of performing the plurality of rounds of grouping on the audio TS packets; and

outputting one or more video TS packet groups acquired each time at least one round of grouping is performed on the video TS packets in the process of performing the plurality of rounds of grouping on the video TS packets;

wherein one of the one or more audio TS packet groups and one of the one or more video TS packet groups are output alternately.

In some embodiments, the computer program product, when loaded and run on the electronic device, causes the electronic device to perform, is caused the electronic device to perform:

caching the ES data of audio frames and the ES data of video frames input into the audio and video encoder within a reference unit time period.

All embodiments of the present disclosure may be performed alone or in combination with other embodiments, which fall within the scope of the present disclosure.

What is claimed is:

1. A method for encoding audio and video data, applicable to an audio and video encoder, the method comprising:
encapsulating cached elementary stream (ES) data of audio frames into at least one audio packetized elementary stream (PES) packet, and encapsulating cached ES data of video frames into at least one video PES packet, wherein the audio frames and the video frames belong to a same video file;
splitting the audio PES packet into at least two consecutive audio transport stream (TS) packets, and splitting the video PES packet into at least two consecutive video TS packets; and
outputting one or more audio TS packet groups based on an order of the audio frames, and outputting one or more video TS packet groups based on an order of the video frames, wherein the audio TS packet group includes at least one audio TS packet, and the video TS packet group includes at least one video TS packet;
wherein in an output order of the one or more audio TS packet groups and the one or more video TS packet groups, at least one of the one or more video TS packet groups is present between the audio TS packet groups belonging to a same audio PES packet, and at least one of the one or more audio TS packet groups is present between the video TS packet groups belonging to different video PES packets.

2. The method according to claim 1, further comprising:
organizing audio TS packets split from the same audio PES packet into at least two audio TS packet groups; and
organizing video TS packets split from the same video PES packet into one video TS packet group.

3. The method according to claim 2, wherein organizing the audio TS packets split from the same audio PES packet into the at least two audio TS packet groups comprises:
acquiring a plurality of audio TS packet groups by performing, based on audio frame decoding timestamps (DTSs) corresponding to the ES data of the audio frames, a plurality of rounds of grouping on the split audio TS packets; and
said organizing the video TS packets split from the same video PES packet into one video TS packet group comprises:
acquiring a plurality of video TS packet groups by performing, based on video frame DTSs corresponding to the ES data of the video frames, a plurality of rounds of grouping on the split video TS packets.

4. The method according to claim 3, wherein said acquiring the plurality of audio TS packet groups by performing, based on the audio frame DTSs corresponding to the ES data of the audio frames, the plurality of rounds of grouping on the split audio TS packets comprises:
selecting audio TS packets, whose DTSs are minimum, from currently ungrouped audio TS packets, wherein the DTSs corresponding to the audio TS packets are a minimum audio frame DTS in the audio frame DTSs corresponding to the ES data of the audio frames in the audio TS packets; and
organizing the selected audio TS packets into a group.

5. The method according to claim 3, wherein said acquiring the plurality of video TS packet groups by performing, based on the video frame DTSs corresponding to the ES data of the video frames, the plurality of rounds of grouping on the split video TS packets comprises:
selecting video TS packets, whose DTSs are minimum, from currently ungrouped video TS packets, wherein the DTSs of the video TS packets are a minimum video frame DTS in the video frame DTSs corresponding to the ES data of the video frames in the video TS packets; and
organizing the selected video TS packets into a group.

6. The method according to claim 3, wherein said outputting the one or more audio TS packet groups based on the order of the audio frames, and outputting the one or more video TS packet groups based on the order of the video frames comprises:
determining the output order of the one or more audio TS packet groups and the one or more video TS packet groups in response to performing the plurality of rounds of grouping on the audio TS packets and the video TS packets; and
outputting the one or more audio TS packet groups and the one or more video TS packet groups based on the determined output order.

7. The method according to claim 6, wherein said outputting the one or more audio TS packet groups and the one or more video TS packets group based on the determined output order comprises:
outputting the one or more audio TS packet groups in an ascending order of the DTSs corresponding to the audio TS packets in the one or more audio TS packet groups, and outputting the one or more video TS packet groups in an ascending order of the DTSs corresponding to the video TS packets in the one or more video TS packet groups, wherein one of the one or more audio TS packet groups and one of the one or more video TS packet groups are output alternately.

8. The method according to claim 3, wherein said outputting the one or more audio TS packet groups based on the order of the audio frames, and outputting the one or more video TS packet groups based on the order of the video frames comprises:
outputting one or more audio TS packet groups acquired each time at least one round of grouping is performed on the audio TS packets in performing the plurality of rounds of grouping on the audio TS packets; and
outputting one or more video TS packet groups acquired each time at least one round of grouping is performed on the video TS packets in performing the plurality of rounds of grouping on the video TS packets;
wherein one of the one or more audio TS packet groups and one of the one or more video TS packet groups are output alternately.

9. The method according to claim 1, further comprising:
caching the ES data of audio frames and the ES data of video frames input into the audio and video encoder within a reference unit time period.

10. An electronic device comprising:
a processor; and
a memory configured to store one or more instructions executable by the processor;
wherein the processor, when loading and executing the one or more instructions, is caused to perform:
encapsulating cached elementary stream (ES) data of audio frames into at least one audio packetized elementary stream (PES) packet, and encapsulating cached ES data of video frames into at least one video PES packet, wherein the audio frames and the video frames belong to a same video file;
splitting the audio PES packet into at least two consecutive audio transport stream (TS) packets, and splitting the video PES packet into at least two consecutive video TS packets; and
outputting one or more audio TS packet groups based on an order of the audio frames, and outputting one or more video TS packet groups based on an order of the video frames, wherein the audio TS packet group includes at least one audio TS packet, and the video TS packet group includes at least one video TS packet;
wherein in an output order of the one or more audio TS packet groups and the one or more video TS packet groups, at least one of the one or more video TS packet group is present between the audio TS packet groups belonging to a same audio PES packet, and at least one of the one or more audio TS packet groups is present between the video TS packet groups belonging to different video PES packets.

11. The electronic device according to claim 10, wherein the processor, when loading and executing the one or more instructions, is caused to perform:
organizing audio TS packets split from the same audio PES packet into at least two audio TS packet groups; and
organizing video TS packets split from the same video PES packet into one video TS packet group.

12. The electronic device according to claim 11, wherein the processor, when loading and executing the one or more instructions, is caused to perform:
acquiring a plurality of audio TS packet groups by performing, based on audio frame decoding timestamps (DTSs) corresponding to the ES data of the audio frames, a plurality of rounds of grouping on the split audio TS packets; and
acquiring a plurality of video TS packet groups by performing, based on video frame DTSs corresponding to the ES data of the video frames, a plurality of rounds of grouping on the split video TS packets.

13. The electronic device according to claim 12, wherein the processor, when loading and executing the one or more instructions, is caused to perform:
selecting audio TS packets, whose DTSs are minimum, from currently ungrouped audio TS packets, wherein the DTSs corresponding to the audio TS packets are a minimum audio frame DTS in the audio frame DTSs corresponding to the ES data of audio frames in the audio TS packets; and
organizing the selected audio TS packets into a group.

14. The electronic device according to claim 12, wherein the processor, when loading and executing the one or more instructions, is caused to perform:
selecting video TS packets, whose DTSs are minimum, from currently ungrouped video TS packets, wherein the DTSs corresponding to the video TS packets are a minimum video frame DTS in the video frame DTSs corresponding to the ES data of video frames in the video TS packets; and
organizing the selected video TS packets into a group.

15. The electronic device according to claim 12, wherein the processor, when loading and executing the one or more instructions, is caused to perform:
determining the output order of the one or more audio TS packet groups and the one or more video TS packet groups in response to performing the plurality of rounds of grouping on the audio TS packets and the video TS packets; and outputting the one or more audio TS packet groups and the one or more video TS packet groups based on the determined output order.

16. The electronic device according to claim 15, wherein the processor, when loading and executing the one or more instructions, is caused to perform:
outputting the one or more audio TS packet groups in an ascending order of the DTSs corresponding to the audio TS packets in the one or more audio TS packet groups, and outputting the one or more video TS packet groups in an ascending order of the DTSs corresponding to the video TS packets in the one or more video TS packet groups, wherein one of the one or more audio TS packet groups and one of the one or more video TS packet groups are output alternately.

17. The electronic device according to claim 12, wherein the processor, when loading and executing the one or more instructions, is caused to perform:
outputting one or more audio TS packet groups acquired each time at least one round of grouping is performed on the audio TS packets in performing the plurality of rounds of grouping on the audio TS packets; and
outputting one or more video TS packet groups acquired each time at least one round of grouping is performed on the video TS packets in performing the plurality of rounds of grouping on the video TS packets;
wherein one of the one or more audio TS packet groups and one of the one or more video TS packet groups are output alternately.

18. The electronic device according to claim 10, wherein the processor, when loading and executing the one or more instructions, is caused to perform:
caching the ES data of audio frames and the ES data of video frames input into the electronic device within a reference unit time period.

19. A non-transitory computer readable storage medium storing one or more instructions therein, wherein the one or more instructions, when loaded and executed by a processor of an electronic device, cause the electronic device to perform:
encapsulating cached elementary stream (ES) data of audio frames into at least one audio packetized elementary stream (PES) packet, and encapsulating cached ES data of video frames into at least one video PES packet, wherein the audio frames and the video frames belong to a same video file;
splitting the audio PES packet into at least two consecutive audio transport stream (TS) packets, and splitting the video PES packet into at least two consecutive video TS packets; and
outputting one or more audio TS packet groups based on an order of the audio frames, and outputting one or more video TS packet groups based on an order of the video frames, wherein the audio TS packet group includes at least one audio TS packet, and the video TS packet group includes at least one video TS packet;
wherein in an output order of the one or more audio TS packet groups and the one or more video TS packet groups, at least one of the one or more video TS packet group is present between the audio TS packet groups belonging to a same audio PES packet, and at least one of the one or more audio TS packet groups is present between the video TS packet groups belonging to different video PES packets.

20. The storage medium according to claim 19, wherein the one or more instructions, when loaded and executed by the processor of the electronic device, cause the electronic device to perform:
organizing audio TS packets split from the same audio PES packet into at least two audio TS packet groups; and
organizing video TS packets split from the same video PES packet into one video TS packet group.
